(19) United States
(12) Patent Application Publication
(10) Pub. No.: US 2014/0039134 A1
(43) Pub. Date: Feb. 6, 2014

(54) POLYAMIDE COMPOSITION

(71) Applicants: Marnix Van Gurp, Echt (NL); Pim Gerard Anton Janssen, Echt (NL); Gerard Jan Kwant, Echt (NL)

(72) Inventors: Marnix Van Gurp, Echt (NL); Pim Gerard Anton Janssen, Echt (NL); Gerard Jan Kwant, Echt (NL)

(73) Assignee: DSM IP ASSETS B.V., Heerlen (NL)

(21) Appl. No.: 13/982,957

(22) PCT Filed: Feb. 14, 2012
(86) PCT No.: PCT/EP12/52512

§ 371 Date: Oct. 15, 2013

(30) Foreign Application Priority Data
Feb. 17, 2011 (EP) 11154838.4

(51) Int. Cl. C08L 77/06

(52) U.S. Cl. CPC C08L 77/06
USPC 525/432

(57) ABSTRACT

Polyamide composition comprising a first polyamide, characterized in that the composition further comprises polyamide-PXD10 in an amount of at least 0.01 wt %, based on the total amount of polyamides in the composition. In a preferred embodiment of the invention, the first polyamide is an aliphatic polyamide chosen from the group of polyamide-6, polyamide-66 and polyamide-46. A fuel part, comprising the polyamide composition is also claimed.

The present invention relates to a polyamide composition comprising a first polyamide, such as for example polyamide-6 or polyamide-66 and a fuel part, comprising the polyamide composition.

Such polyamide compositions are known in the art. These compositions may suffer from a low fuel permeation resistance. It is known that the fuel permeation resistance of polyamides present in such compositions may be low, in particular for fuels containing alcohols such as ethanol. For example, polyamide-6 and polyamide-66 suffer from such a low resistance. Increasing such resistance is highly desirable as alcohol containing fuels are more and more applied.

It is therefore an object of the present invention to increase the fuel permeation resistance of such a polyamide composition, in particular the resistance against permeation of alcohol containing fuels.

This has surprisingly been achieved in that the polyamide composition further comprises polyamide-PXD10 (poly(p-xylylene sebacamide); also referred to as PA-PXD10) as second polyamide in an amount of at least 0.01 wt % based on the total amount of polyamides in the composition.

The nomenclature is adhered to as used in Nylon Plastics Handbook, Melvin I. Kohan, Hanser Publishers, 1995; e.g. PA-612 denotes a homopolymer with building blocks hexane-1,6-diamine and dodecanoic acid, PA-6/12 denotes a copolymer made from ε-caprolactam and laurolactam and a blend of PA-6 and PA-12 is described as PA-6/PA-12.

It has surprisingly been found that the fuel permeation resistance, in particular for fuels containing alcohols such as ethanol, of the composition can be increased to an extent much higher than one would expect from the individual fuel permeation resistances of the first polyamide and of polyamide-PXD10.

Yet another advantage of the present invention is that polyamide-PXD10 surprisingly shows to be miscible with the first polyamide. This is exemplified by melting point depression as well as crystallization point depressions of the composition, compared to the melting points of the separate polyamides.

The polyamide composition according to the invention can be obtained by blending polyamide-PXD10 with at least the first polyamide at a temperature at which all polyamides are molten. Preferably, the blending is performed without transamidation catalyst, in order to avoid the formation of a random-copolymer.

The composition according to the invention comprises polyamide-PXD10. The amount of polyamide-PXD10 in the composition of the present invention is at least 0.01wt %, with respect to the total amount of polyamides. Preferably, the amount of PA-PXD10 is at least 1 wt %, more preferably at least 5wt %, even more preferably at least 10 wt %, even more preferably at least 15 wt. % and even more preferably at least 20 wt. %. Any percentages between these values are also possible, such as 0.5, 2, 3, 4, 6, 7, 8, 9, 11, 12, 13, 14, 16, 17, 18 and 19 wt %. All percentages are based on the total amount of polyamides in the composition, unless stated otherwise. The higher the amount of polyamide-PXD10, the more pronounced the beneficial effect of polyamide-PXD10 on the fuel permeation resistance of the composition of the present invention. The amount of polyamide-PXD10 in the composition of the present invention is preferably at most 99 wt. %, more preferably at most 95 wt %, more preferably at most 90 wt. %, even more preferably at most 85 wt. %, even more preferably at most 80 wt. %, even more preferably at most 70 wt. %, even more preferably at most 60 wt. % and even more preferably at most 50 wt. %.

Surprisingly even very low amounts of polyamide-PXD10 in the composition according to the invention already exhibited a significant increase in fuel permeation resistance, which is exemplified in the examples An advantage of low amounts of polyamide-PXD10, such as preferably at most 20 wt % with respect to the total amount of polyamide, is that the oxygen permeability remains sufficient under dry conditions as well as humid conditions, i.e. at 85% relative humidity.

The polyamide-PXD10 can for example be obtained by the method described in WO2010032692.

The first polyamide can be any polyamide other than polyamide-PXD10. Suitable first polyamides in the composition according to the invention include aliphatic polyamides, semi-aromatic or aromatic polyamides. Non-limiting examples of aliphatic polyamides are polyamide-6, polyamide-46, polyamide-66, polyamide-11, polyamide-12, polyamide-410, polyamide-510, polyamide-610 . Non-limiting examples of semi-aromatic polyamides are polyamide-MXD6, polyamide-61/6T, polyamide-66/6T.

In one embodiment of the present invention, the composition comprises an aliphatic polyamide as first polyamide. Preferably, the composition comprises as first polyamide polyamide-6, polyamide-66 or polyamide-46 or copolyamides of the constituting monomers thereof. More preferably, the composition comprises polyamide-6 or polyamide-66 as the fuel permeation resistance, in particular for alcohol containing fuels, of these polyamides is low.

The amount of first polyamide in the composition of the present invention preferably ranges from 1 wt % up to and including 99.99 wt. %, with respect to the total amount of polyamides. Preferably, the amount of first polyamide is preferably higher than 5 wt %, more preferably higher than 10 wt %, even more preferably higher than 15 wt %, even more preferably higher than 20 wt. %, even more preferably higher than 25 wt. % and even more preferably higher than 30 wt. %. Any percentages between these values are also possible, such as 2, 3, 4, 6, 7, 8, 9, 11, 12, 13, 14, 16, 17, 18 and 19 wt %. In a particular preferred embodiment, the composition comprises at least 50 wt. % of first polyamide.

The amount of the first polyamide in the composition of the present invention is preferably at most 95 wt %, more preferably at most 90 wt. %, even more preferably at most 85 wt. % and even more preferably at most 80 wt. %. Any percentages between these values are also possible, such as 94, 93, 92, 91, 89, 88, 87, 86, 84, 83, 82 and 81 wt %.

In a preferred embodiment of the present invention, the first polyamide is polyamide-6 or polyamide-66 that is present in the composition.

In another preferred embodiment of the present invention, the first polyamide is polyamide-6 or polyamide-66 that is present in the composition and polyamide-PXD10 is present in an amount between 5 to 25 wt % with respect to the total amount of polyamides. This combines the beneficial fuel permeability properties which are present in relative low amounts of polyamide-PXD10 with economic properties of higher amounts of polyamide-6 or polyamide-66.

In a third embodiment of the present invention, the first polyamide is a polyamide with a melting temperature as measured by DSC at 10° C. per minute of less than the melting temperature of polyamide-PXD10.

The polyamide composition according to the invention may further comprise a third polyamide. The third polyamide can be any polyamide other than the first polyamide and polyamide-PXD10. Suitable third polyamides in the composition according to the invention include aliphatic polyamides, semi-aromatic or aromatic polyamides. Non-limiting examples of aliphatic polyamides are polyamide-6, polyamide-46, polyamide-66, polyamide-11, polyamide-12, polyamide-410, polyamide-510, polyamide-610. Non-limiting examples of semi-aromatic polyamides are polyamide-MXD6, polyamide-61/6T, polyamide-66/6T.

Preferably, the amount of third polyamide is preferably higher than 5 wt %, more preferably higher than 10 wt %, even more preferably higher than 15 wt %, even more preferably higher than 20 wt. %, even more preferably higher than 25 wt. % and even more preferably higher than 30 wt. %. Any percentages between these values are also possible, such as 2, 3, 4, 6, 7, 8, 9, 11, 12, 13, 14, 16, 17, 18 and 19 wt %. The amount of the third polyamide in the composition of the present invention is preferably at most 90 wt. %, more preferably at most 80 wt. %, even more preferably at most 70 wt. %, even more preferably at most 60 wt. %, and even more preferably at most 50 wt. %.

In a preferred embodiment of the present invention, the first polyamide is polyamide-6, the third polyamide is polyamide-66 which are both present in the composition in an amount ranging from 10 wt. % up to and including 90 wt. % and the amount of polyamide-PXD10 ranging from 10 wt. % up to and including 80 wt. %.

Preferably, the sum of the amounts of first polyamide and polyamide-PXD10 is at least 80 wt. %, more preferably at least 90 wt. % and even more preferably 100 wt. %, relative to the total amount of polyamides in the composition.

The composition according to the invention may further comprise usual additives. Examples of such additives are flame-retardants, fillers, in particular mineral fillers, release agents, lubricants and impact modifiers. Usually in automotive applications the composition may also contain glass fibres and fillers. In general the amount of polyamides in the composition is between 40 and 95 wt %, relative to the total composition. Fillers may be present in an amount of up to 40 wt % (relative to the total composition), preferably between 10 and 40 wt % and glass fiber may be present in an amount up to 50 wt % (relative to the total composition), preferably between 5 and 50 wt % . Other functional additives may be present in the usual effective amounts as known in the art.

The polyamide composition according to the invention can advantageously be used in the production of a fuel part. A fuel part can be a monolithic or monolayer part. Examples are housings of a fuel pump, tabs and monolayer fuel container. Production methods such as injection molding and blow-molding are known to provide monolayer fuel parts. This has the advantage that the method for production is simple and allows for high degree of design freedom. A fuel part comprising a polyamide composition according to the invention as a monolayer, has the advantage that either the fuel permeability is lower or that the monolayer can be thinner to achieve the same fuel permeability. Another advantage of a monolayer part is that the fuel permeation is more homogeneous and that no pinching occurs.

A fuel part can also be a multilayer part. Examples of multilayer parts are multilayer fuel containers, multilayer fuel canister and multilayer fuel hoses. Multilayer fuel parts are usually made by blow-molding or by extrusion. One or more layers are then made from the polyamide composition comprising according to the invention. A multilayer fuel part has the advantage that the properties of various layers can be advantageously combined. Other layers might include high density poly ethylene (HDPE), ethylene vinyl alcohol (EVOH), tie-layers which are beneficial for various reasons. HDPE has a positive influence on impact, moisture absorption and chemical resistance. EVOH is known for its low fuel permeation. Tie-layers are used for their overall strength. Another advantage of a multilayer fuel part comprising the polyamide composition according to the invention is that the decreased fuel permeation of the polyamide composition allows either for a simplified design of the fuel part, such as thinner layers, or less layers, or a lower fuel permeation of the whole fuel part.

Fuel parts can be made with known processes, such as injection-molding or blow-molding.

Injection molding is here understood to comprise the following steps:
a. heating a polyamide composition to obtain a viscous liquid;
b. filling a mold cavity with the viscous liquid;
c. leaving the viscous liquid in the mold under pressure until it cools and solidifies to form a part;
d. opening the mold;
e. ejecting the part.

Blow-molding is here understood to comprise at least the following steps:
a. heating a polyamide composition to obtain a viscous liquid;
b. forming a parison from the viscous liquid;
c. expand the parison by pressurized gas and press it against a mold cavity until it cools and solidifies to form a part;
d. opening the mold;
e. ejecting the part.

The invention will be elucidated by the following examples. Amounts are denoted in wt % based on the total amount of polyamides in the composition, unless stated otherwise.

A polyamide composition (example I and II) as specified in Table 1, polyamide-6 (Comp Ex A) are injection molded into plaques having a circular form and having dimensions of 60 mm in diameter and 1.0 mm in thickness. The fuel permeation rate is measured by the weight loss method according to ASTM E96BW in which water has been replaced by ASTM fuel CE10 (composed of 10 vol. % ethanol and 90 vol. % of ASTM fuel C (50/50 wt % mixture of toluene and iso-octane)). The fuel permeation measurements are performed at 40° C. The cup is filled with 20 ml of the fuel CE10. The tested plaque is mounted above the cavity on the cup and placed between two flat gaskets. The gaskets are made of Viton (low permeation fluorocarbon elastomer) and also possess a cavity of the same size as the fuel cup. The cup is closed by a steel lid with an opening in the middle matching the cup cavity. The lid is fixed and tightened with the screws. The gaskets are located between the two steel parts of the cup and are not in contact with the fuel. Their purpose is to prevent leakage of the fuel from the fuel cup.

TABLE 1

| | First polyamide | | Fuel |
|---|---|---|---|
| Example | and amount in | Amount PA-PXD10 in | permeability |
| number | wt % | wt %, MW 38 kg/mol | [g mm/m² day] |
| Comp. A | PA6 100 ηᵣₑₗ = 2.2 | 0 | 5.93 |
| I | PA6 99 | 1 | 3.1 |
| II | PA6 98 | 2 | 3.6 |

Examples I and II show a decreased fuel permeability with respect to Comparative Example A.

1. Polyamide composition comprising a first polyamide, characterized in that the composition further comprises polyamide-PXDI O as a second polyamide in an amount of at least 0.01 wt %, based on the total amount of polyamides in the composition.

2. Polyamide composition according to claim 1 characterized in that the amount of polyamide-PXDIO is at least 0.5 wt %, based on the total amount of polyamides in the composition.

3. Polyamide composition according to claim 1, characterized in that the amount of polyamide-PXDIO is at least 5 wt %, based on the total amount of polyamides in the composition.

4. Polyamide composition according to claim 1, characterized in that the amount of polyamide-PXDIO is at least 10 wt %, based on the total amount of polyamides in the composition.

5. Polyamide composition according to claim 1, characterized in that the amount of polyamide-PXDIO is at least 20 wt %, based on the total amount of polyamides in the composition.

6. Polyamide composition according to claim 1, characterized in that the amount of polyamide-PXDI O is at most 90 wt. %.

7. Polyamide composition according to claim 1, characterized in that the amount of polyamide-PXDIO is at most 80 wt. %.

8. Polyamide composition according to above claim 1, characterized in that the first polyamide is an aliphatic polyamide.

9. Polyamide composition according to claim 1, characterized in that the first polyamide is chosen from the group of polyamide-6, polyamide-66 and polyamide-46.

10. Polyamide composition according to claim 1, characterized in that the first polyamide is chosen from the group of polyamide-6 and polyamide-66.

11. Polyamide composition according to above claim 1, characterized in that the composition comprises at least 50 wt. % of first polyamide.

12. Polyamide composition according to claim 1, characterized in that the composition comprises at most 90 wt. % of first polyamide.

13. Polyamide composition according to claim 1, characterized in that the composition further comprises a third polyamide.

14. Polyamide composition according to claim 13, characterized in that the third polyamide is chosen from the group of polyamide-6 and polyamide-66.

15. Fuel part, comprising the polyamide composition according to claim 1.
